(19) United States
(12) Patent Application Publication
(10) Pub. No.: US 2011/0115908 A1
(43) Pub. Date: May 19, 2011

(54) SURVEILLANCE CAMERA

(75) Inventor: Maki TATSUNO, Osaka-shi (JP)

(73) Assignee: SANYO ELECTRIC CO., LTD., Osaka (JP)

(21) Appl. No.: 12/945,711

(22) Filed: Nov. 12, 2010

(30) Foreign Application Priority Data
Nov. 13, 2009 (JP) 2009-259503

(51) Int. Cl. H04N 7/18

(52) U.S. Cl. 348/143; 348/E07.085

(57) ABSTRACT

A surveillance camera includes an imager. An imager has an imaging surface capturing a scene. A first detector strictly detects a reference direction in response to an initializing operation. A first adjuster adjusts a direction of the imaging surface by referring to a detected result of the first detector. A changer changes a direction of the imaging surface in response to a change operation after the initializing operation. A second detector simply detects the reference direction when the direction of the imaging surface is changed irrespective of the change process of the changer. A second adjuster adjusts the direction of the imaging surface with reference to a detected result of the second detector.

### CROSS REFERENCE OF RELATED APPLICATION

The disclosure of Japanese Patent Application No. 2009-259503, which was filed on Nov. 13, 2009, is incorporated herein by reference.

### BACKGROUND OF THE INVENTION

1. Field of the Invention

The present invention relates to a surveillance camera. More particularly, the present invention relates to a surveillance camera that is applied to a dome-type surveillance camera, for example, and changes a shooting direction in response to a pan/tilt operation.

2. Description of the Related Art

According to one example of this type of camera, when an impact that exceeds a threshold value is applied to a surveillance camera apparatus, a control signal is applied to a zoom drive portion from a control portion. The zoom drive portion moves a zoom lens group arranged in a lens device to a wide end side in response to the control signal applied from the control portion. Thereby, it becomes possible to photograph or specify a person who acts in an obstructive behavior to the surveillance camera apparatus.

However, in the above-described camera, the lens device is exposed to outside. Thus, when the person who acts in an obstructive behavior applies external force to the lens device, a direction of the lens device is changed to a direction different from a setting direction. The above-described camera is not intended to detect such obstructive act, and thus, a surveillance capability is limited.

### SUMMARY OF THE INVENTION

A surveillance camera according to the present invention, comprises: an imager having an imaging surface capturing a scene; a first detector which strictly detects a reference direction in response to an initializing operation; a first adjuster which adjusts a direction of the imaging surface by referring to a detected result of the first detector; a changer which changes the direction of the imaging surface in response to a change operation after the initializing operation; a second detector which simply detects the reference direction when the direction of the imaging surface is changed irrespective of the change process of the changer; and a second adjuster which adjusts the direction of the imaging surface by referring to a detected result of the second detector.

A surveillance control program product according to the present invention is a surveillance control program product executed by a processor of a surveillance camera provided with an imager having an imaging surface capturing a scene, comprises: a first detecting step of strictly detecting a reference direction in response to an initializing operation; a first adjusting step of adjusting the direction of the imaging surface by referring to a detected result of the first detecting step; a changing step of changing the direction of the imaging surface in response to a change operation after the initializing operation; a second detecting step of simply detecting the reference direction when the direction of the imaging surface is changed irrespective of the change process of the changing step; and a second adjusting step of adjusting the direction of the imaging surface by referring to a detected result of the second detecting step.

A surveillance control method according to the present invention is a surveillance control method executed by a surveillance camera provided with an imager having an imaging surface capturing a scene, comprises: a first detecting step of strictly detecting a reference direction in response to an initializing operation; a first adjusting step of adjusting the direction of the imaging surface by referring to a detected result of the first detecting step; a changing step of changing the direction of the imaging surface in response to a change operation after the initializing operation; a second detecting step of simply detecting the reference direction when the direction of the imaging surface is changed irrespective of the change process of the changing step; and a second adjusting step of adjusting the direction of the imaging surface by referring to a detected result of the second detecting step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2 is a block diagram showing one example of a configuration of a surveillance camera applied to one embodiment of the present invention;

FIG. 3 is a block diagram showing one example of a configuration of a controller applied to one embodiment of the present invention;

FIG. 4 is an illustrative view showing one example of pan/tilt behavior of an imaging surface;

FIG. 5(A) is an illustrative view showing one portion of pan rotating behavior;

FIG. 5(B) is an illustrative view showing one portion of tilt rotating behavior;

FIG. 6 is a side surface view showing a configuration of the embodiment in FIG. 2;

FIG. 7 is a front surface view showing the configuration of the embodiment in FIG. 2;

FIG. 8 is a top surface view showing the configuration of the embodiment in FIG. 2;

FIG. 9 is an illustrative view showing one portion of pan behavior of the embodiment in FIG. 2;

FIG. 10 is an illustrative view showing one portion of tilt behavior of the embodiment in FIG. 2;

FIG. 11 is a perspective view showing one example of a configuration of a photointerruptor applied to the embodiment in FIG. 2;

FIG. 12 is a perspective view showing one example of a configuration of another photointerruptor applied to the embodiment in FIG. 2;

FIG. 13(A) is an illustrative view showing another portion of the pan behavior of the embodiment in FIG. 2;

FIG. 13(B) is an illustrative view showing still another portion of the pan behavior of the embodiment in FIG. 2;

FIG. 14(A) is an illustrative view showing another portion of the tilt behavior of the embodiment in FIG. 2;

FIG. 14(B) is an illustrative view showing still another portion of the tilt behavior of the embodiment in FIG. 2;

FIG. 15 is a flowchart showing one portion of behavior of a controller CPU applied to the embodiment in FIG. 3;

FIG. 16 is a flowchart showing one portion of behavior of a main CPU applied to the embodiment in FIG. 2;

FIG. 17 is a flowchart showing another portion of the behavior of the main CPU applied to the embodiment in FIG. 2;

FIG. 18 is a flowchart showing still another portion of the behavior of the main CPU applied to the embodiment in FIG. 2;

FIG. 19 is a flowchart showing yet another portion of the behavior of the main CPU applied to the embodiment in FIG. 2;

FIG. 20 is a flowchart showing another portion of the behavior of the main CPU applied to the embodiment in FIG. 2; and

FIG. 21 is a flowchart showing another portion of the behavior of the main CPU applied to the embodiment in FIG. 2.

### DETAILED DESCRIPTION OF THE PREFERRED EMBODIMENTS

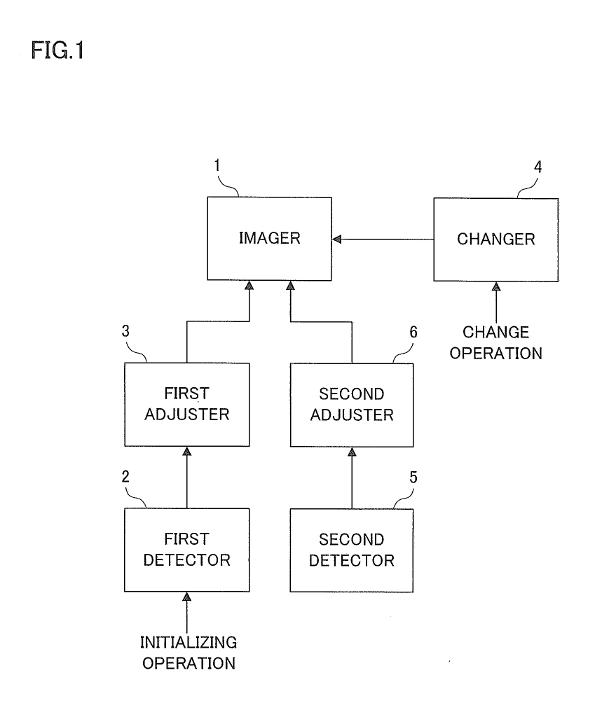

With reference to FIG. 1, a surveillance camera according to one embodiment of the present invention is basically configured as follows: An imager 1 has an imaging surface capturing a scene. A first detector 2 strictly detects a reference direction in response to an initializing operation. A first adjuster 3 adjusts a direction of the imaging surface by referring to a detected result of the first detector 2. A changer 4 changes a direction of the imaging surface in response to a change operation after the initializing operation. A second detector 5 simply detects the reference direction when the direction of the imaging surface is changed irrespective of the change process of the changer 4. A second adjuster 6 adjusts the direction of the imaging surface with reference to a detected result of the second detector 5.

Thus, the direction of the imaging surface changed irrespective of the change operation is adjusted via a simple process for detecting the reference direction. Therefore, even when the direction of the imaging surface is forcedly changed by a suspicious person who has invaded a monitored zone, it is possible to quickly restore the direction of the imaging surface by referring to the simply detected reference direction. Thereby, a surveillance capability is improved.

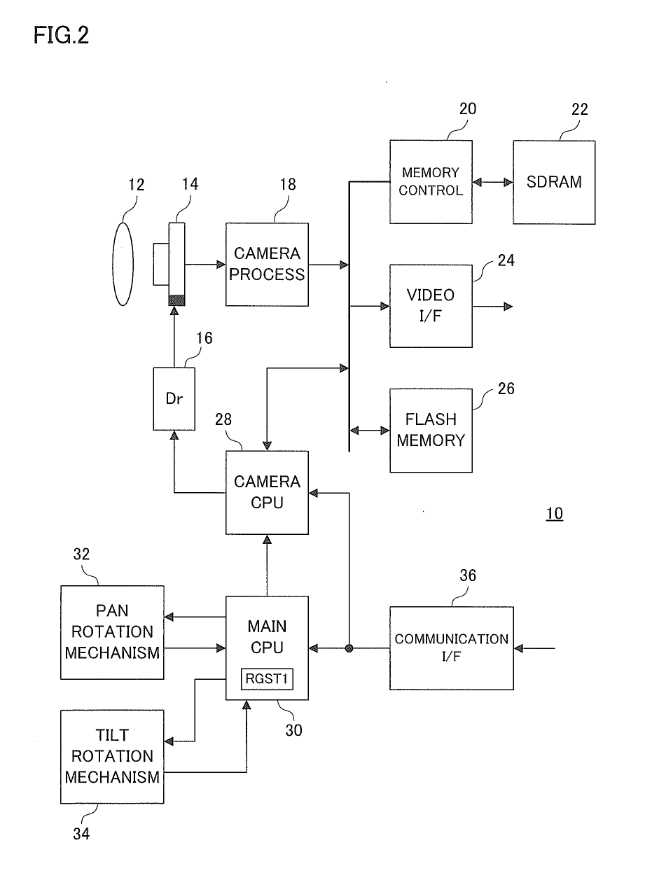

With reference to FIG. 2, a surveillance camera 10 according to this embodiment is a camera, installed on an indoor ceiling, for monitoring an interior from above. The surveillance camera 10 includes an optical lens 12 and an image sensor 14. An optical image representing a scene or one portion of a monitored zone enters, with irradiation, the imaging surface of the image sensor 14 via the optical lens 12.

When a power-source applying operation is performed, a strict original-point detecting process (described in detail later) is executed by a main CPU 30. Thereby, a pan angle θp and a tilt angle θt are set to an original-point angle in a pan direction and an original-point angle in a tilt direction, respectively. It is noted that the “original point” may be called as a “home position”.

After completion of the original-point detecting process, a camera CPU 28 commands a driver 16 to repeat exposure behavior and electric-charge reading-out behavior. In response to a cyclically generated timing signal, the driver 16 executes exposing the imaging surface and reading-out the electric charges produced as a result of the exposure. From the image sensor 14, raw image data based on the electric charges read out from the imaging surface is repeatedly outputted.

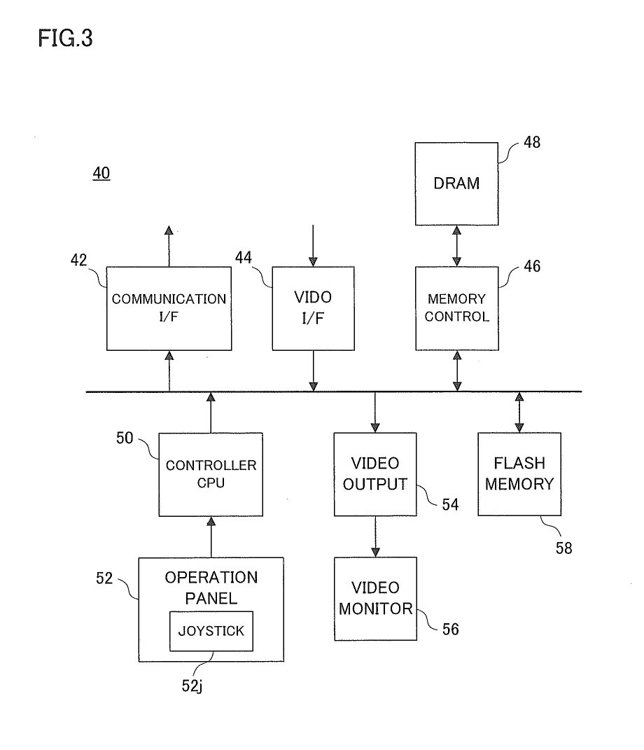

A camera processing circuit 18 performs processes, such as color separation, white balance adjustment, and YUV conversion on the raw image data outputted from the image sensor 14, and writes YUV formatted-image data produced as a result of these processes onto an SDRAM 22 through a memory control circuit 20. A video I/F 24 reads out the image data accommodated in the SDRAM 22 through the memory control circuit 20, and sends the read-out image data toward an external device 40 shown in FIG. 3.

With reference to FIG. 3, the image data sent from the surveillance camera 10 is received by a video I/F 44, and written into a DRAM 48 by a memory control circuit 46. A video output circuit 54 reads out the image data accommodated in the DRAM 48 through the memory control circuit 46, and displays an image that is based on the read-out image data, on a video monitor 56. As a result, a real-time moving image representing the monitored zone is displayed on a monitor screen.

On an operation panel 52, a joystick 52j for instructing a pan rotation and/or a tilt rotation of the surveillance camera 10 is arranged. However, the pan rotation and/or the tilt rotation may also be instructed by a GUI operation.

When an operator inclines the joystick 52j, a controller CPU 50 repeatedly creates pan/tilt operation information in which a direction parameter corresponding to an inclined direction of the joystick 52j and a speed parameter corresponding to an inclined angle of the joystick 52j are written, and sends the created pan/tilt operation information to the surveillance camera 10 via a communication I/F 42.

When the operator releases the joystick 52j, the joystick 52j is returned by resilience to an initial state (a state where the stick stands upright). The controller CPU 50 creates only one pan/tilt stop information instead of the pan/tilt operation information, and sends the created pan/tilt stop information to the surveillance camera 10 via the communication I/F 42.

Returning to FIG. 2, a communication I/F 36 takes in the pan/tilt operation information, pan/tilt stop information, and zoom operation information transmitted from the external device 40, and applies the pan/tilt operation information and the pan/tilt stop information to the main CPU 30.

The main CPU 30 issues a pan/tilt rotation instruction that matches the direction parameter and the speed parameter written in the pan/tilt operation information, toward a pan rotation mechanism 32 and/or a tilt rotation mechanism 34. Also in the pan/tilt rotation instruction, the rotation direction and the rotation speed are written. As a result, an orientation of the imaging surface is changed to a desired direction at a desired speed.

When the pan/tilt stop information is applied, the main CPU 30 issues a pan/tilt stop instruction toward the pan rotation mechanism 32 and/or the tilt rotation mechanism 34. As a result, a change in behavior of the imaging surface's orientation is stopped. Furthermore, in association with the pan/tilt stop instruction, the main CPU 30 detects a pan angle θp and a tilt angle θt at a current time point, and registers the detected pan angle θp and tilt angle θt as “θp_R” and “θt_R” into a register RGST1.

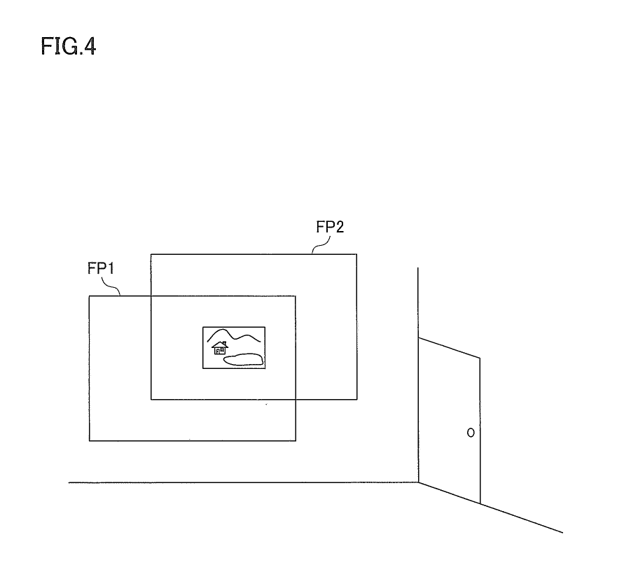

When a zone shown in FIG. 4 is equivalent to the monitored zone, an angle of coverage of the scene captured on the imaging surface is transitioned from “FP1” to “FP2”, for example, by such pan/tilt behavior.

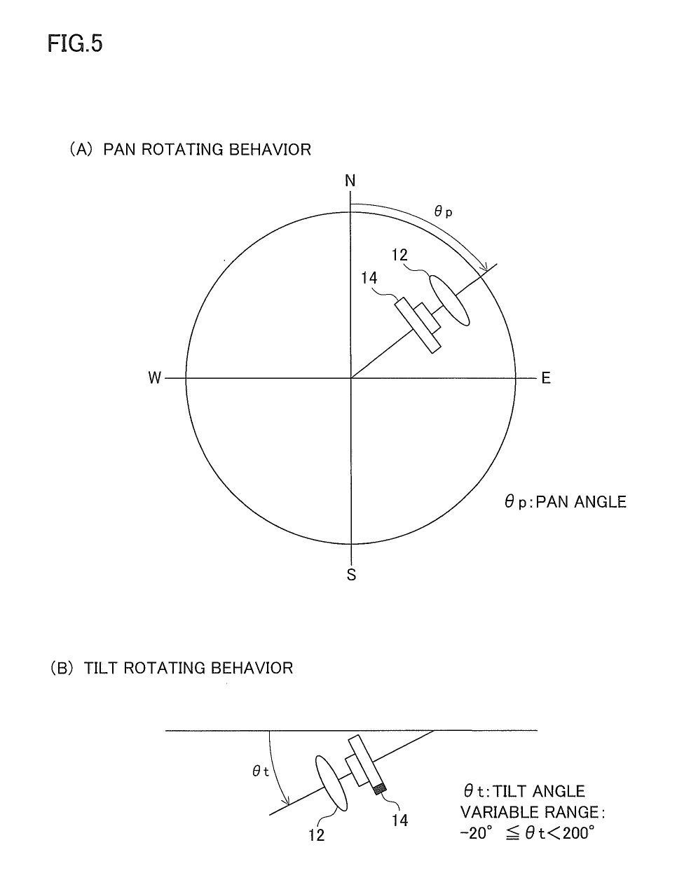

With reference to FIG. 5(A), the pan angle θp is a parameter defining a horizontal angle of an optical axis perpendicular to the imaging surface, and increases along a clockwise direction where a horizontal angle obtained when the imaging surface is oriented, for example to the true north is used as an original point angle (=0 degree or 360 degrees) in the pan direction. Therefore, the pan angle θp indicates 90, 180, and 270 degrees, respectively, corresponding to the true east, the true south, and the true west. It is noted that a variable range of the pan angle θp is not limited, and as long as the pan operation information is applied, the pan rotating behavior is executed endlessly. Moreover, the direction defining the original angle in the pan direction is not necessarily the true north.

With reference to FIG. 5(B), the tilt angle θt is a parameter defining a vertical angle of the optical axis perpendicular to the imaging surface, and increases along a downward direction where a vertical angle obtained when the imaging surface is orientated to a horizontal direction with making an upper end of the image sensor 14 face upward is used as an original point angle (=0 degree) in the tilt direction. The tilt angle et indicates 90 degrees when the imaging surface is oriented directly underneath, and indicates 180 degrees when the imaging surface is oriented to the horizontal direction with making the upper end of the image sensor 14 face downward. It is noted that a variable range of the tilt angle θt is −20 degrees≦θ≦200 degrees.

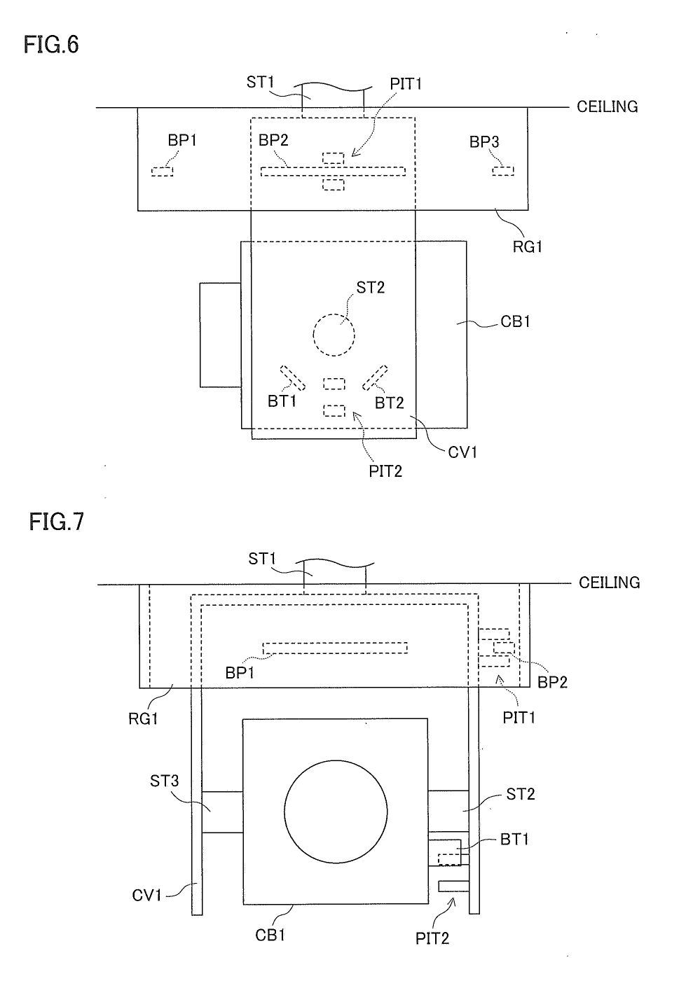

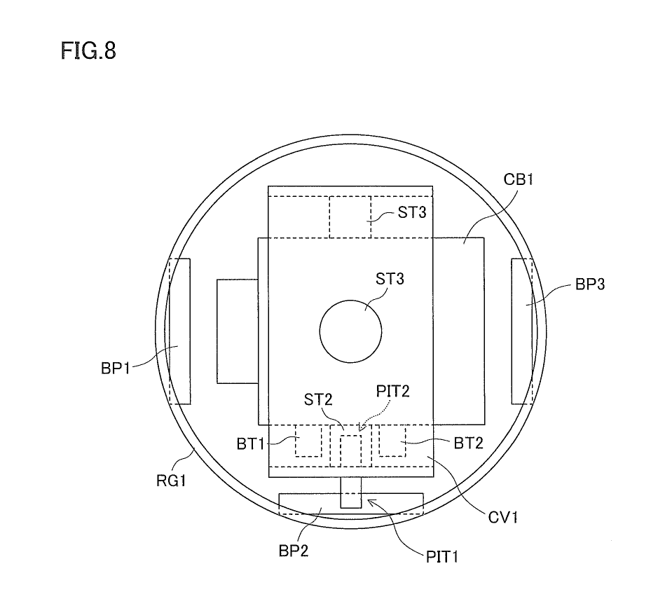

With reference to FIG. 6 to FIG. 8 showing an appearance of the surveillance camera 10, a top surface, a left-side surface, and a right-side surface of a camera cabinet CB1 are covered with a plate-like cover CV1 bent in a U-lettered shape. One side end of a shaft ST1 extending in a vertical direction is joined to a surface covering the top surface of the camera cabinet CB1, out of outer-side surfaces of the cover CV1. The shaft ST1 is one portion of members configuring the pan rotation mechanism 32, and the other end of the shaft ST1 is arranged through the ceiling to be joined to another member configuring the pan rotation mechanism 32.

On the other hand, on the left-side surface and the right-side surface of the camera cabinet CB1, there are arranged shafts ST2 and ST3 protruding in a horizontal direction in a manner to be orthogonal to the optical axis. The shafts ST2 and SD are one portion of members configuring the tilt rotation mechanism 34. A distal end of the shaft ST2 is joined to a surface covering the left-side surface of the camera cabinet CB1, out of inner-side surfaces of the cover CV1, and on the other hand, a distal end of the shaft SD is joined to a surface covering the right-side surface of the camera cabinet CB1, out of the inner-side surfaces of the cover CV1.

A ring RG1 is arranged on the ceiling so that a center of a cross section orthogonal to a length direction of the shaft ST1 (hereinafter, briefly referred to as a “cross-sectional center of the shaft ST1”) and a center of a cross section orthogonal to a thickness direction of the ring RG1 coincide with each other and the length direction of the shaft ST1 and the thickness direction of the ring RG1 coincide with each other.

On an inner-side surface of the ring RG1, strip-like blades BP1 to BP3 having the same dimension as one another are mounted. The blades BP1 to BP3 are each one portion of members configuring the pan rotation mechanism 32 and mounted to the ring RG1 so that length directions and width directions of the blades BP1 to BP3 coincide with a horizontal direction and height positions of the blades BP1 to BP3 coincide with one another.

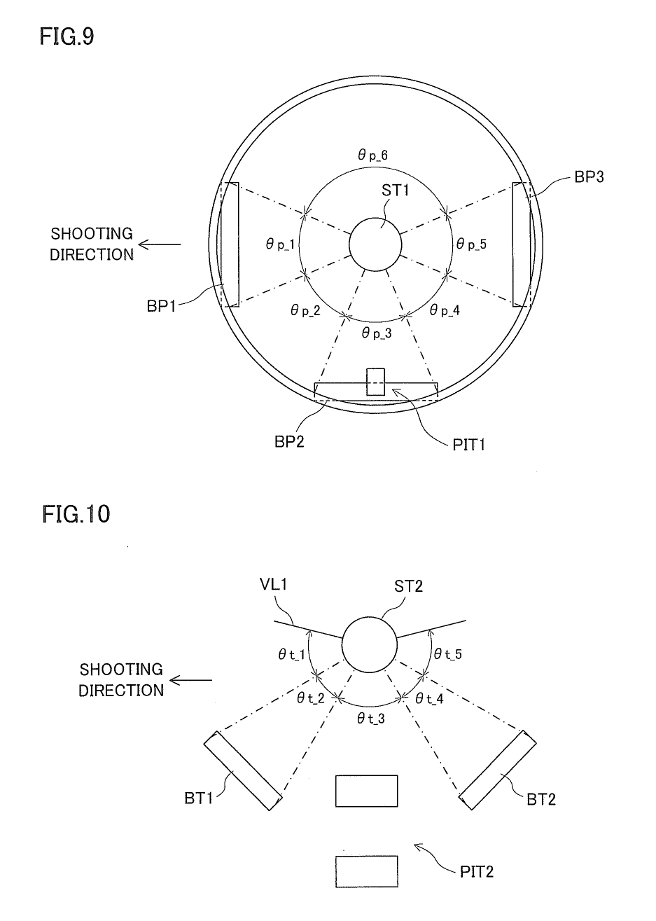

With reference to FIG. 9, an angle faulted between a straight line extending toward one end of the length direction of the blade BP1 from the cross-sectional center of the shaft ST1 and a straight line extending toward the other end of the length direction of the blade BP1 from the cross-sectional center of the shaft ST1 is equivalent to “θp_1”.

An angle formed between a straight line extending toward the other end of the length direction of the blade BP1 from the cross-sectional center of the shaft ST1 and a straight line extending toward one end of the length direction of the blade BP2 from the cross-sectional center of the shaft ST1 is equivalent to “θp_2”.

An angle formed between a straight line extending toward one end of the length direction of the blade BP2 from the cross-sectional center of the shaft ST1 and a straight line extending toward the other end of the length direction of the blade BP2 from the cross-sectional center of the shaft ST1 is equivalent to “θp_3”.

An angle formed between a straight line extending toward the other end of the length direction of the blade BP2 from the cross-sectional center of the shaft ST1 and a straight line extending toward one end of the length direction of the blade BP3 from the cross-sectional center of the shaft ST1 is equivalent to “θp_4”.

An angle formed between a straight line extending toward one end of the length direction of the blade BP3 from the cross-sectional center of the shaft ST1 and a straight line extending toward the other end of the length direction of the blade BP3 from the cross-sectional center of the shaft ST1 is equivalent to “θp_5”.

An angle formed between a straight line extending toward the other end of the length direction of the blade BP3 from the cross-sectional center of the shaft ST1 and a straight line extending toward one end of the length direction of the blade BP1 from the cross-sectional center of the shaft ST1 is equivalent to “θp_6”.

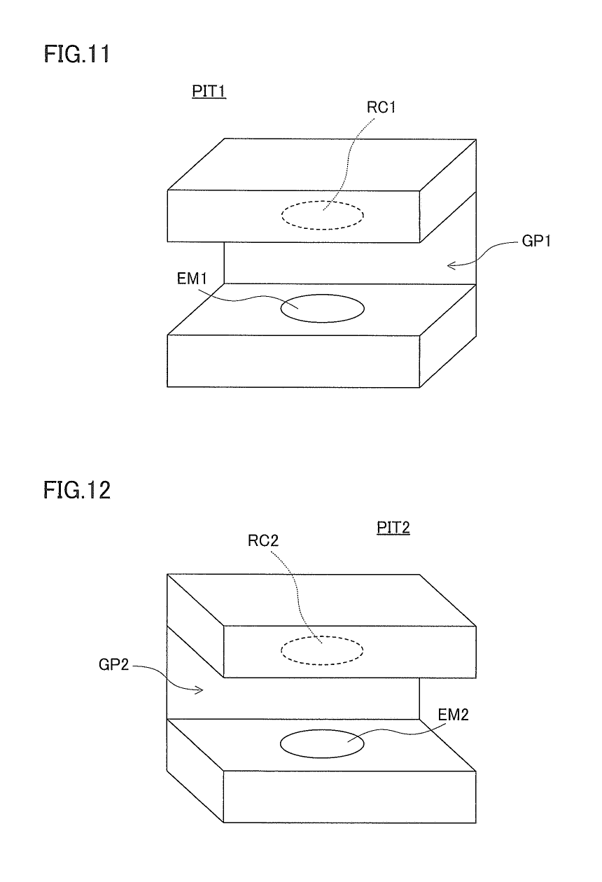

On a surface covered with the ring RG1, out of outer-side surfaces of the cover CV1, a transmissive-type photointerruptor PIT1 is arranged corresponding to height positions of the blades BP1 to BP3. With reference to FIG. 11, the photointerruptor PIT1 is one portion of members configuring the pan rotation mechanism 32, and has a width larger than thicknesses of the blades BP1 to BP3 and includes a gap GP1 extending in a horizontal direction. A light-emitting element EM1 and a light-receiving element RC1 are arranged in the gap GP1 in a manner to face each other.

When the camera cabinet CB1 is rotated in the pan direction around the shaft ST1 that is used as a reference, the blades BP1 to BP3 pass through the gap GP1 of the photointerruptor PIT1. Light migrating from the light-emitting element EM1 to the light-receiving element RC1 is shielded intermittently by the blades BP1 to BP3. Output of the light-receiving element RC1, i.e., output of the photointerruptor PIT1, indicates an H level when the blades BP1 to BP3 do not shield the light and indicates an L level when the blades BP1 to BP3 shield the light.

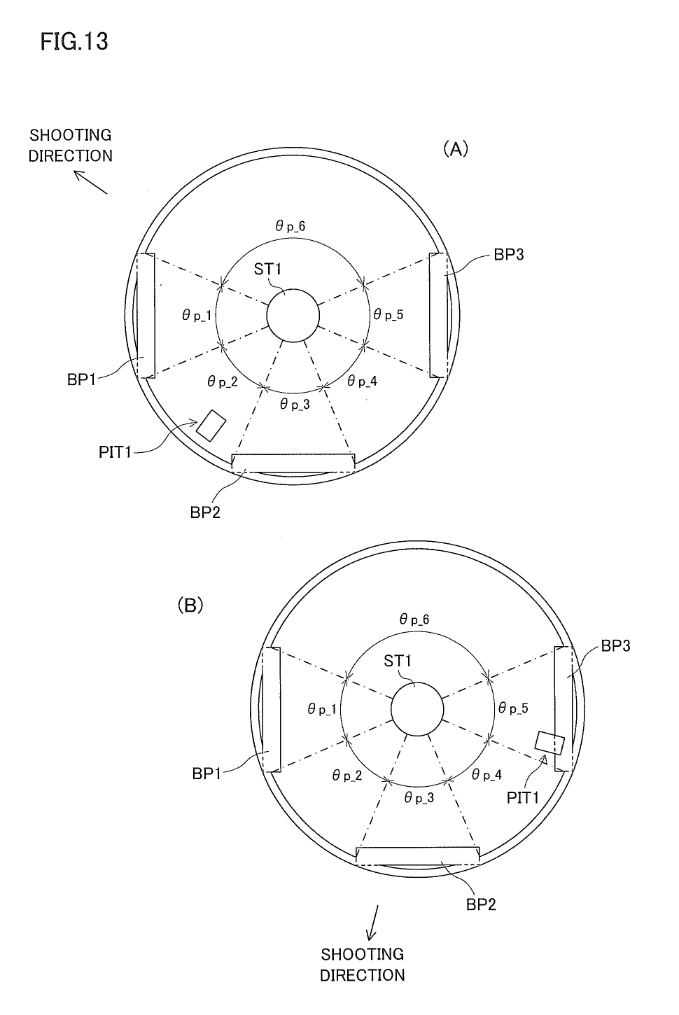

Therefore, when the imaging surface is oriented to a direction shown in FIG. 13(A), the output of the photointerruptor PIT1 indicates the H level. Moreover, when the imaging surface is oriented to a direction shown in FIG. 13(B), the output of the photointerruptor PIT1 indicates the L level.

Returning to FIG. 6 to FIG. 8, on the left-side surface of the camera cabinet CB1, ship-like blades BT1 and BT2 having the same dimension to each other are mounted. Either one of the blade BT1 or BT2 is one portion of members configuring the tilt rotation mechanism 34, and is mounted at a position separated by a predetermined distance from a center of a cross section orthogonal to a length direction of the shaft ST2 (hereinafter, briefly referred to as a “cross-sectional center of the shaft ST2”) toward a radial direction of the shaft ST2. At this time, a width direction of each of the blades BT1 and BT2 coincides with a circumferential direction of the shaft ST2.

With reference to FIG. 10, when a straight line of a V-lettered shape defining a variable range of the tilt angle θt is defined as “VL1”, an angle formed between a straight line extending toward one end of the length direction of the blade BT1 from the cross-sectional center of the shaft ST2 and one side of the straight line VL1 is equivalent to “θt_1”.

An angle formed between a straight line extending toward one end of the length direction of the blade BT1 from the cross-sectional center of the shaft ST2 and a straight line extending toward the other end of the length direction of the blade BT1 from the cross-sectional center of the shaft ST2 is equivalent to “θt_2”.

An angle formed between a straight line extending toward the other end of the length direction of the blade BT1 from the cross-sectional center of the shaft ST2 and a straight line extending toward one end of the length direction of the blade BT2 from the cross-sectional center of the shaft ST2 is equivalent to “θt_3”.

An angle formed between a straight line extending toward one end of the length direction of the blade BT2 from the cross-sectional center of the shaft ST2 and a straight line extending toward the other end of the length direction of the blade BT2 from the cross-sectional center of the shaft ST2 is equivalent to “θt_4”.

An angle formed between a straight line extending toward the other end of the length direction of the blade BT2 from the cross-sectional center of the shaft ST2 and another side of the straight line VL1 is equivalent to “θt_5”.

On a surface covering the left-side surface of the camera cabinet CB1, out of the inner-side surfaces of the cover CV1, a transmissive-type photointerruptor PIT2 is arranged corresponding to a position equivalent to a distance to each of the blades BT1 and BT2 from the cross-sectional center of the shaft ST2. With reference to FIG. 12, the photointenuptor PIT2 is one portion of members configuring the tilt rotation mechanism 34, and has a width larger than thicknesses of the blades BT1 and BT2 and includes a gap GP2 extending in a horizontal direction. A light-emitting element EM2 and a light-receiving element RC2 are arranged in the gap GP2 in a manner to face each other.

When the camera cabinet CB1 is rotated in the tilt direction around the shaft ST2 that is used as a reference, the blades BT1 and BT2 pass through the gap GP2 of the photointenuptor PIT2. Light migrating from the light-emitting element EM2 to the light-receiving element RC2 is shielded intermittently by the blades BT1 and BT2. Output of the light-receiving element RC2 indicates an H level when the blades BT1 and BT2 do not shield the light and indicates an L level when the blades BT1 and BT2 shield the light.

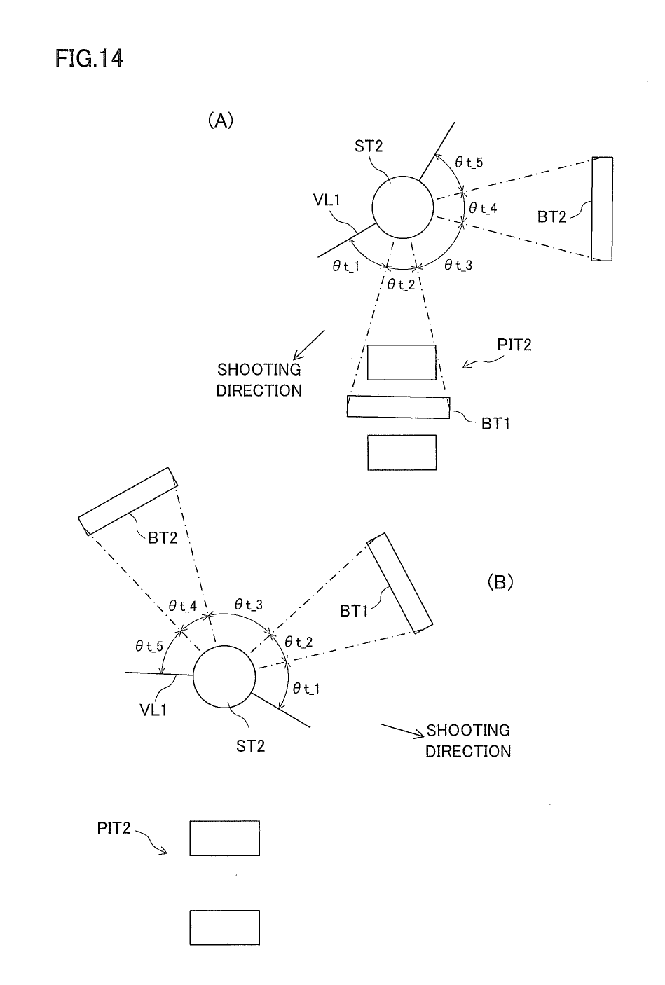

Therefore, when the imaging surface is oriented to a direction shown in FIG. 14(A), the output of the photointerruptor PIT2 indicates the L level. Moreover, when the imaging surface is oriented to a direction shown in FIG. 14(B), the output of the photointerruptor PIT2 indicates the H level.

Output levels of the photointerruptors PIT1 and PIT2 are registered onto the register RGST1 by the CPU 30 at a time point at which the pan angle θp and the tilt angle θt are set to the original point angles. The registered output levels are updated by the main CPU 30 at each completion of the pan/tilt behavior that complies with the pan/tilt operation information. Thereby, basically, the output levels registered on the register RGST1 come to coincide with the output levels of the photointerruptors PIT1 and PIT2.

However, if a suspicious person who has invaded the monitored zone applies external force to the camera cabinet CB1 to forcedly change the pan angle θp and/or the tilt angle θt, then at least one of the changed output levels of the photointerruptors PIT1 and PIT2 is differed from the output level registered on the register RGST1, depending on the amount of change.

In such a case, the main CPU 30 executes a simple original-point detecting process to specify the original point angle of the pan direction and the original point angle of the tilt direction. Furthermore, the main CPU 30 refers to the specified original point angles and the pan angle θp_R and the tilt angle θt_R registered on the register RGST1 to restore the pan angle θp and/or the tilt angle θt to the angles before the forced change by the suspicious person. Thereby, it becomes possible to continuously capture the scene that has been captured before the forced change.

A common point and a different point between the sitict original-point detecting process and the simple original-point detecting process are as follows:

In either one of the original-point detecting processes, firstly, a pan rotation instruction in which the rotation direction is described is repeatedly issued toward the pan rotation mechanism 32. Thereby, the pan angle θp is changed successively into a designated direction. Along with the successive change of the pan angle θp, the output level of the photointerruptor PIT1 changes in a pulse manner between the H level and the L level. The issuance of the pan rotation instruction is interrupted at a time point at which an edge count of such a pulse exceeds a threshold value TH1. Moreover, the original point angle in the pan direction is specified by monitoring the change in output level of the photointerruptor PIT1.

Subsequently, a tilt rotation instruction in which the rotation direction is described is issued toward the tilt rotation mechanism 34. Thereby, the tilt angle θt is changed in a designated direction. Along with the successive change of the pan angle θt, the output level of the photointerruptor PIT2 changes in a pulse manner between the H level and the L level. The issuance of the tilt rotation instruction is interrupted at a time point at which an edge count of such a pulse exceeds a threshold value TH2. Moreover, the original point angle in the tilt direction is specified by monitoring the change in output level of the photointerruptor PIT2.

However, between the strict original-point detecting process and the simple original-point detecting process, there is a difference in change amount between the pan angle θp and the tilt angle θt. That is, the change amounts of the pan angle θp and the tilt angle θt in the simple original-point detecting process are smaller than the change amounts of the pan angle θp and the tilt angle θt in the strict original-point detecting process.

As described above, the original point angle in the pan direction is specified based on the output of the photointerruptor PIT1 taken in parallel with the change behavior of the pan angle θp, and the original point angle of the tilt direction is specified based on the output of the photointerruptor PIT2 taken in parallel with the change behavior of the tilt angle θt. Therefore, if the change amounts of the pan angle θp and the tilt angle θt are large, then it is possible to specify the original point angle with high precision even though it takes time. In contrary, if the change amounts of the pan angle θp and the tilt angle θt are small, then the precision for the original point angle is lowered even though it saves time.

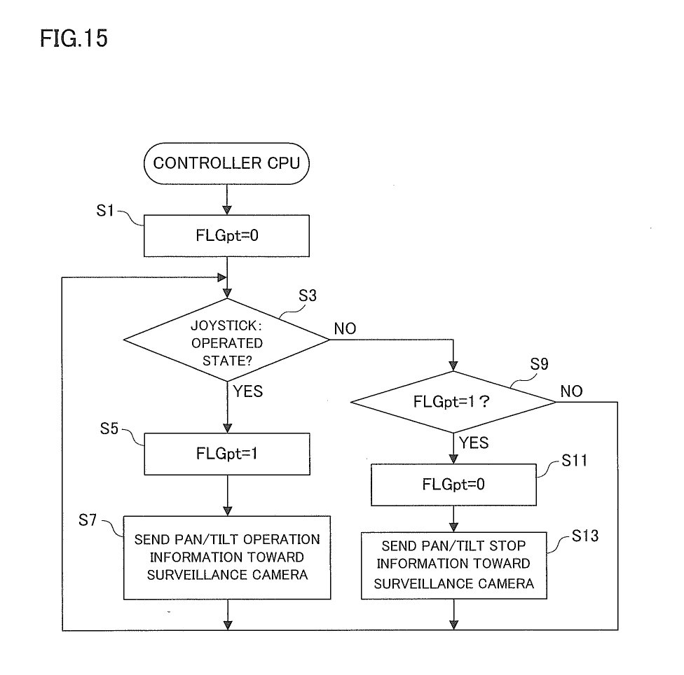

The controller CPU 50 arranged in the external device 40 executes a process along a flowchart shown in FIG. 15. It is noted that a control program corresponding to this flowchart is stored in a flash memory 58.

Firstly, in a step S1, a flag FLGpt is set to “0”. The flag FLGpt is a flag for declaring whether the joystick 52j is in an operated state or in a released state, and “1” indicates the operated state while “0” indicates the released state.

In a step S3, it is determined whether or not the joystick 52j is in the operated state, and when YES is determined, the flag FLGpt is set to “1” in a step S5. In a subsequent step S7, the pan/tilt operation information corresponding to the operated state of the joystick 52j is created, and the created pan/tilt operation information is sent toward the surveillance camera 10.

When NO is determined in the step S3, i.e., when the joystick 52j is in the released state, whether or not the flag FLGpt is “1” is determined in a step S9. When YES is determined in this step, the flag FLGpt is set to “0” in a step S11, and the pan/tilt stop information is sent toward the surveillance camera 10 in a step S13.

Upon completion of the process in the step S7 or S13 or when NO is determined in the both steps S3 and S9, the process returns to the step S3.

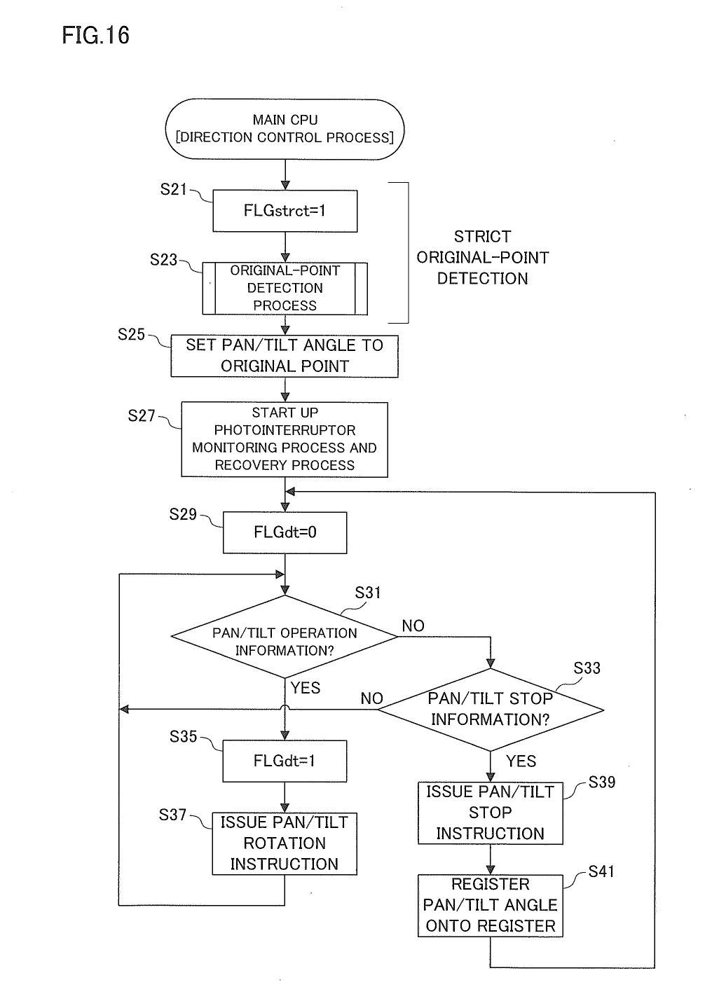

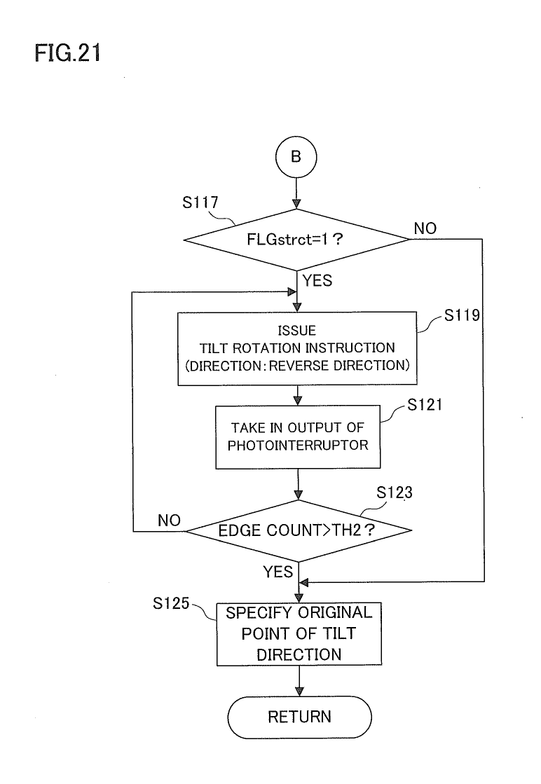

The main CPU 30 arranged in the surveillance camera 10 executes a process along a flowchart shown in FIG. 16 to FIG. 21. It is noted that a control program corresponding to these flowcharts is stored in a flash memory 26.

With reference to FIG. 16, a flag FLGstrct is set to “1” in a step S21, and in a step S23, the original-point detecting process in which the flag FLGstrct is referred to is executed. The flag FLGstrct is a flag for identifying the precision of the original point detection, and “1” indicates the strict original-point detection while “0” indicates the simple original-point detection. Therefore, in the step S23, the original point angle in the pan direction and the original point angle in the tilt direction are strictly detected. In a step S25, the pan rotation mechanism 32 and the tilt rotation mechanism 34 are driven to set the pan angle θp and the tilt angle θt to the detected original point angles.

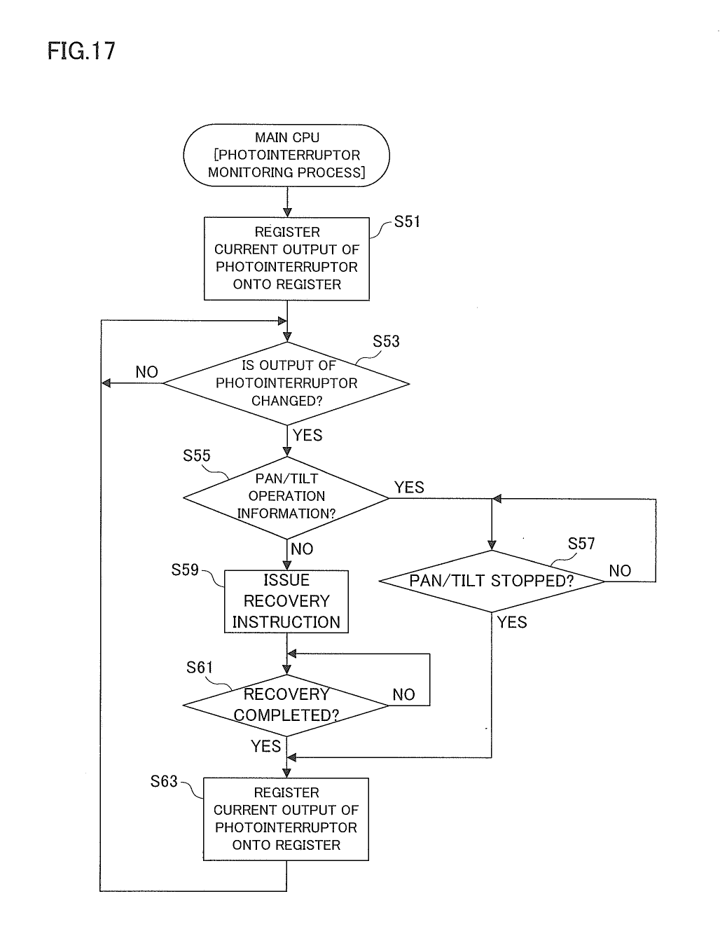

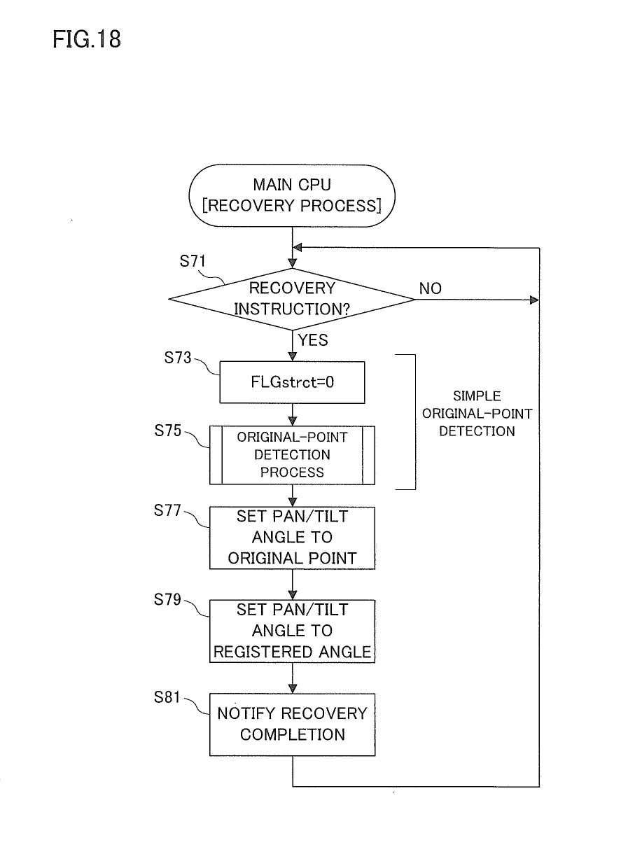

Upon completion of the process in the step S25, a photointerruptor monitoring process shown in FIG. 17 and a recovery process shown in FIG. 18 are started up in a step S27, and a flag FLGdt is set to “0” in a step S29. The flag FLGdt is a flag for identifying whether the pan/tilt behavior is in an executed state or a stopped state, and “1” indicates the executed state while “0” indicates the stopped state. Upon completion of the process in the step S29, whether or not the pan/tilt operation information is received is determined in a step S31, and whether or not the pan/tilt stop information is received is determined in a step S33.

When YES is determined in the step S31, the flag FLGdt is set to “1” in a step S35. In a step S37, the pan/tilt rotation instruction is issued toward the pan rotation mechanism 32 and/or the tilt rotation mechanism 34. Upon completion of the process in the step S37, the process returns to the step S31.

When YES is determined in the step S33, the process advances to a step S39 so as to issue the pan/tilt stop instruction toward the pan rotation mechanism 32 and/or the tilt rotation mechanism 34. In a subsequent step S41, the pan angle θp and the tilt angle θt obtained at a time point at which the pan/tilt behavior is stopped are registered onto the register RGST1 as “θp_R” and “θt_R”. Thereafter, the process returns to the step S29.

With reference to FIG. 17, in a step S51, the current output levels of the photointerruptors PIT1 and PIT2 are registered onto the register RGST1. In a step S53, whether or not at least one of the output levels of the photointerruptors PIT1 and PIT2 is changed is determined by referring to the output levels registered on the register RGST1. When a determined result is updated from NO to YES, whether or not the pan/tilt operation information is being received is determined in a step S55.

If the pan/tilt operation information is being received, then the process advances to a step S57 so as to prepare for the stopping of the pan/tilt behavior that has responded to the above-described process in the step S39. When the pan/tilt behavior is stopped, YES is determined in the step S57. Then, the process advances to a step S63. In the step S63, a process similar to that in the step S51 is executed, and after completion of the process, the process returns to the step S53.

If the pan/tilt operation information is not being received, then the process advances to a step S59 so as to issue the recovery instruction toward the photointerruptor monitoring process. In a step S61, it is determined whether or not a recovery completion is notified from the photointerruptor monitoring process, and when a determined result is updated from NO to YES, the process advances to the step S63.

With reference to FIG. 18, in a step S71, whether or not the recovery instruction is issued from the photointerruptor monitoring process is determined. When a determined result is updated from NO to YES, the flag FLGstrct is set to “0” in a step S73, and the original-point detecting process in which the flag FLGstrct is referred to is executed in a step S75. Thereby, the original point angle in the pan direction and the original point angle in the tilt direction are simply detected.

In a step S77, the pan rotation mechanism 32 and the tilt rotation mechanism 34 are driven to set the pan angle θp and the tilt angle θt to the detected original point angles. In a step S79, the pan rotation mechanism 32 and the tilt rotation mechanism 34 are similarly driven so as to set the pan angle θp and the tilt angle θt to the pan angle θp_R and the tilt angle θt_R registered on the register RGST1. Upon completion of the process in the step S79, the photointerruptor monitoring process is notified of the recovery completion in a step S81, and thereafter, the process returns to the step S71.

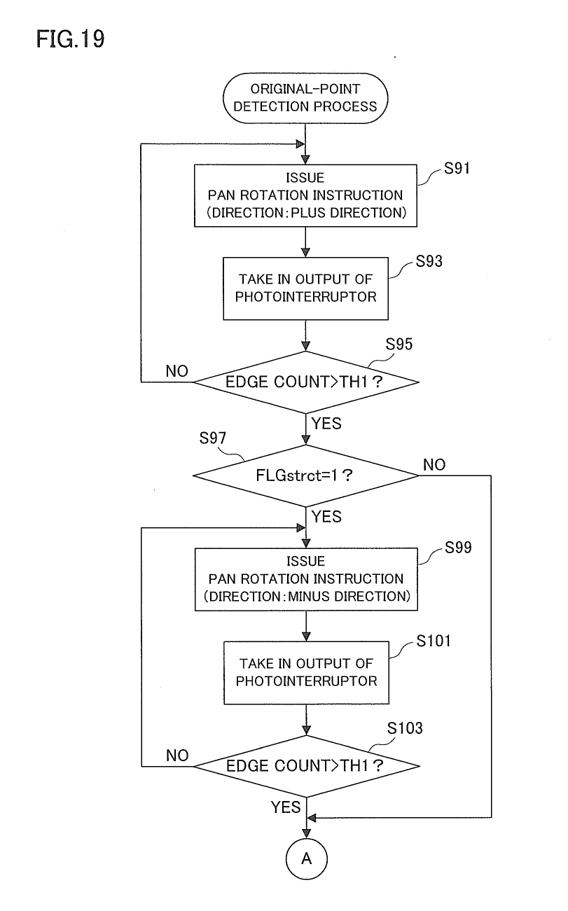

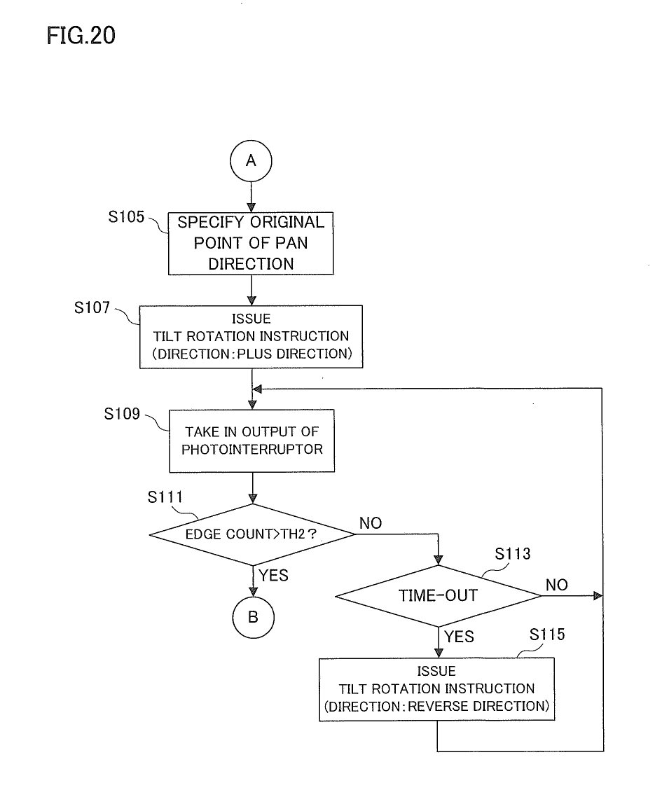

The original-point detecting processes in the step S23 shown in FIG. 16 and in the step S75 shown in FIG. 18 are executed along a subroutine shown in FIG. 19 and FIG. 20.

Firstly, in a step S91, a pan rotation instruction in which a plus rotation direction is described is issued toward the pan rotation mechanism 32. The pan angle θp changes in an increasing direction. In a step S93, the output of the photointerruptor PIT1 is taken in, and in a step S95, it is determined whether or not the edge count of the pulse outputted from the photointerruptor PIT1 exceeds the threshold value TH1. When a determined result is NO, the process returns to the step S91, and when the determined result is YES, the process advances to a step S97. In the step S97, whether or not the flag FLGstrct indicates “1” is determined, and when a determined result is NO, the process directly advances to a step S105 and when the determined result is YES, the process advances to a step S99.

In the step S99, a pan rotation instruction in which a minus rotation direction is described is issued toward the pan rotation mechanism 32. The pan angle θp changes in a decreasing direction. In a step S101, the output of the photointerruptor PIT™ is taken in, and in a step S103, it is determined whether or not the edge count of the pulse outputted from the photointerruptor PIT1 exceeds the threshold value TH1. When a determined result is NO, the process returns to the step S99, and when the determined result is YES, the process advances to the step S105. In a step S105, the original point angle in the pan direction is specified based on the output of the photointerruptor PIT1 taken in the step S93 and/or S101.

In a step S107, a tilt rotation instruction in which the plus rotation direction is described is issued toward the tilt rotation mechanism 34. The tilt angle θt changes in an increasing direction. In a step S109, the output of the photointerruptor PIT2 is taken in, and in a step S111, it is determined whether or not the edge count of the pulse outputted from the photointerruptor PIT2 exceeds the threshold value TH2. In a step S113, it is determined whether or not an allotted time is consumed (time-out) without the edge count exceeding the threshold value TH2.

When NO is determined in the both steps S111 and S113, the process directly returns to the step S109, and when YES is determined in the step S113, the process returns to the step S109 via a process in a step S115. In the step S115, a pan rotation instruction in which a reverse rotation direction (=minus rotation direction) is described is issued toward the pan rotation mechanism 32. As a result, the tilt angle θt changes in a decreasing direction.

When YES is determined in the step S111, the process advances to a S117 so as to determine whether or not the flag FLGstrct indicates “1”. When the determined result is NO in the step S117, the process directly advances to a step S125 while when the determined result is YES, the process advances to a step S119.

In the step S115, a tilt rotation instruction in which a reverse rotation direction is described is issued toward the tilt rotation mechanism 34. When the process is transitioned to the step S119 without undergoing the process in the step S115, the tilt angle θt changes in a decreasing direction. In contrary, when the process is transitioned to the step S119 after undergoing the process in the step S115, the tilt angle θt changes in an increasing direction.

In a step S121, the output of the photointerruptor PIT2 is taken in, and in a step S123, it is determined whether or not the edge count of the pulse outputted from the photointerruptor PIT2 exceeds the threshold value TH2. When a determined result is NO, the process returns to the step S119, and when the determined result is YES, the process advances to the step S125. In the step S125, the original point angle in the tilt direction is specified based on the output of the photointerruptor PIT2 taken in the step S109 and/or S121. Upon completion of the process in the step S125, the process is returned to the routine at a hierarchical upper level.

As is seen from the above description, the imager sensor 14 has the imaging surface capturing the object scene. In response to a power-source applying operation (initializing operation), the main CPU 30 strictly detects the original point angle (reference direction) in the pan direction and the original point angle (reference direction) in the tilt direction (S21 to S23), and refers to the detected result so as to adjust the pan angle θp and the tilt angle θt. Moreover, the main CPU 30 changes the pan angle θp and the tilt angle θt in response to the change operation after the initializing operation (S37). Furthermore, when the pan angle θp and/or the tilt angle θt are changed irrespective of the change process of the pan angle θp and/or the tilt angle θt that has responded to the change operation, the main CPU 30 simply detects the original point angle in the pan direction and the original point angle in the tilt direction (S53, S55, S59, and S71 to S75) and adjusts the pan angle θp and the tilt angle θt by referring to the detected result (S77 to S79).

Thus, the direction of the imaging surface changed irrespective of the change operation is adjusted via the simple original-point detecting process. Therefore, even when the direction of the imaging surface is forcedly changed by a suspicious person who has invaded the monitored zone, it is possible to quickly restore the direction of the imaging surface by referring to the simply detected original point angle. Thereby, a surveillance capability is improved.

It is noted that in this embodiment, out of the pan/tilt operation information, the pan/tilt stopping information, and the zoom operation information transmitted from the external device 40, the communication I/F 36 shown in FIG. 2 applies the pan/tilt operation information and the pan/tilt stopping information to the main CPU 30 while applying the zoom operation information to the camera CPU 28. However, it may be possible that all of the pan/tilt operation information, the pan/tilt stopping information, and the zoom operation information are applied to the main CPU 30, and the zoom process is executed under the control of the main CPU 30.

Moreover, in this embodiment, the original-point detecting process is executed by using the photointerruptor; however, the original-point detecting process may be executed by using a sensor other than the photointerruptor.

Furthermore, in this embodiment, the pan rotating behavior and the tilt rotating behavior are individually executed in the original-point detecting process; however, the pan rotating behavior and the tilt rotating behavior may be executed in parallel to each other.

Moreover, in this embodiment, the surveillance behavior including the original point detection and the angular adjustment is achieved by way of a software process; however, the surveillance behavior may be achieved by way of a hardware process. Furthermore, in a case where the surveillance behavior is achieved by way of the software process, the software process may be executed dispersively by using a plurality of CPUs rather than the process is executed by a single CPU.

Moreover, in this embodiment, the angle is detected by using an optical sensor such as a photointerruptor; however, the angle may be detected by using another sensor such as a magnetic sensor using a hole element.

Also, in this embodiment, the external device 40 is a controller having the operation panel 52 and the joystick 52j, and an operator executes the control of the pan/tilt by operating the joystick 52j; however, the operation may be executed by using a device having a similar function other than the controller.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A surveillance camera, comprising:
an imager having an imaging surface capturing a scene;
a first detector which strictly detects a reference direction in response to an initializing operation;
a first adjuster which adjusts a direction of the imaging surface by referring to a detected result of said first detector;
a changer which changes the direction of the imaging surface in response to a change operation after the initializing operation;
a second detector which simply detects the reference direction when the direction of the imaging surface is changed irrespective of the change process of said changer; and
a second adjuster which adjusts the direction of the imaging surface by referring to a detected result of said second detector.

2. A surveillance camera according to claim 1, further comprising a generator which generates an output different depending on the direction of the imaging surface, wherein each of said first detector and said second detector includes: a direction changer which changes the direction of the imaging surface; a taker which takes in the output of said generator in parallel with the change process of said direction changer; and a direction specifier which specifies the reference direction based on the output taken in by said taker.

3. A surveillance camera according to claim 2, wherein said first detector further includes a first amount setter which sets a change amount of said direction changer to a first amount, and said second detector further includes a second amount setter which sets the change amount of said direction changer to a second amount larger than the first amount.

4. A surveillance camera according to claim 2, wherein said generator includes: a sensor having a light-emitting portion and a light-receiving portion arranged at positions facing each other; and a light-shielding member which shields light migrating from said light-emitting portion toward said light-receiving portion depending on the direction of the imaging surface.

5. A surveillance camera according to claim 1, wherein said second detector includes: a determiner which repeatedly determines whether or not the direction of the imaging surface is changed in a period during which the change process of said changer is interrupted; and a detection processor which executes a process for detecting the reference direction when the determined result of said determiner is updated from a negative result to an affirmative result.

6. A surveillance camera according to claim 1, further comprising a registerer which registers the direction of the imaging surface in association with the change process of said changer, wherein said second adjuster adjusts the direction of the imaging surface to the direction registered by said registerer.

7. A surveillance control program product executed by a processor of a surveillance camera provided with an imager having an imaging surface capturing a scene, comprising:
a first detecting step of strictly detecting a reference direction in response to an initializing operation;
a first adjusting step of adjusting the direction of the imaging surface by referring to a detected result of said first detecting step;
a changing step of changing the direction of the imaging surface in response to a change operation after the initializing operation;
a second detecting step of simply detecting the reference direction when the direction of the imaging surface is changed irrespective of the change process of said changing step; and
a second adjusting step of adjusting the direction of the imaging surface by referring to a detected result of said second detecting step.

8. A surveillance control method executed by a surveillance camera provided with an imager having an imaging surface capturing a scene, comprising:
a first detecting step of strictly detecting a reference direction in response to an initializing operation;
a first adjusting step of adjusting the direction of the imaging surface by referring to a detected result of said first detecting step;
a changing step of changing the direction of the imaging surface in response to a change operation after the initializing operation;
a second detecting step of simply detecting the reference direction when the direction of the imaging surface is changed irrespective of the change process of said changing step; and
a second adjusting step of adjusting the direction of the imaging surface by referring to a detected result of said second detecting step.
